(19) United States
(12) Patent Application Publication
(10) Pub. No.: US 2021/0207830 A1
(43) Pub. Date: Jul. 8, 2021

(54) GAS MONITORING APPARATUS AND METHOD

(71) Applicant: CARRIER CORPORATION, Palm Beach Gardens, FL (US)

(72) Inventor: Lei Chen, South Windsor, CT (US)

(21) Appl. No.: 17/059,826

(22) PCT Filed: Sep. 6, 2019
(86) PCT No.: PCT/US2019/049932

§ 371 Date: Nov. 30, 2020

Related U.S. Application Data
(60) Provisional application No. 62/729,091, filed on Sep. 10, 2018.

(51) Int. Cl. F24F 11/36; G01M 3/24

(52) U.S. Cl. CPC F24F 11/36; F24F 2110/65; G01M 3/24

(57) ABSTRACT

A method of monitoring airflow along an airflow path includes measuring a speed or frequency of sound through air on the airflow path. A flow condition of the airflow as active or non-active is determined, based on a measured speed or frequency of sound through air on the airflow path. A presence of a flammable compound is also determined, based on a measured speed or frequency of sound through air on the airflow path. A combination sensor for gas composition flow includes a housing including an active flow inlet, an active flow outlet, and a measured flow path within the housing. First and second ultrasonic transceivers are configured to send and receive a sonic signal along a sonic pathway through the measured flow path. A plurality of diffusion openings in the housing are configured to provide operative molecular diffusion communication between outside of the housing and the sonic pathway.

### BACKGROUND

Exemplary embodiments pertain to the art of gas and airflow monitoring, and more specifically to detection of flammable gases from sources such as heating & cooling and refrigerant systems and mechanically driven airflows.

Gas sensors have been used in various applications such as process monitoring and control and safety monitoring. As the compounds can also be flammable or explosive, gas detection sensors have also been used for leak detection where such compounds are used or manufactured. Various types of sensors and systems have been used or proposed, including but not limited to metal oxide semiconductor (MOS) sensors, non-dispersive infrared detector (NDIR) sensors, pellistor (pelletized resistor) sensors, oxygen ion-permeable high-temperature solid electrolytes, and electrochemical cells, and additional developments continue to be sought.

### BRIEF DESCRIPTION

A method of monitoring airflow along an airflow path is disclosed. According to the method, a speed or frequency of sound through air on the airflow path is measured. A flow condition of the airflow as active or non-active is determined, based on a measured speed or frequency of sound through air on the airflow path. A presence of a flammable compound is also determined, based on a measured speed or frequency of sound through air on the airflow path.

An air conditioning or heat pump system is also disclosed including an airflow path in operative fluid communication with a conditioned space. A first heat exchanger comprises a first side in operative fluid communication with the conditioned airflow path, and a second side in operative thermal communication with the first side and in operative fluid communication with a refrigerant that comprises a flammable compound. The refrigerant is disposed on an enclosed refrigerant flow path that connects the second side of the first heat exchanger with a second heat exchanger in thermal communication with an external heat source or heat sink. An ultrasonic sensor is in operative fluid communication with the airflow path, and is configured to measure a speed of sound through air on the airflow path. The system also includes a microprocessor configured to characterize a flow condition of the airflow as active or non-active by a measured speed or frequency of sound through air on the airflow path. The microprocessor is further configured to determine a presence of the flammable compound by a measured speed or frequency of sound through air on the airflow path.

In some embodiments, the air conditioning or heat pump system refrigerant can have a class 2 or class 2L or class 3 flammability rating according to ASHRAE 34-2016.

In any one or combination of the foregoing embodiments, the airflow path can include a fan configured to induce the active flow condition.

In any one or combination of the foregoing embodiments, the fan is activated in response to the determination of a presence of a flammable compound.

In any one or combination of the foregoing embodiments, the determination of the flow condition is based on transit times of a bi-directional sonic signal across a fixed distance through air on the airflow path.

7 In any one or combination of the foregoing embodiments, the determination of the presence of the flammable compound is based on transit times of a bi-directional sonic signal across a fixed distance through air on the airflow path.

In any one or combination of the foregoing embodiments, the airflow path includes a heater, and wherein activation of the heater requires determination of an active flow condition on the airflow path. In some embodiments, the heater is disposed in an air conditioning or heat pump system as described above, and the heater is activated in response to a system heat demand signal in a condition of heat pump shut-down initiated by a determination of the presence of the flammable compound.

In any one or combination of the foregoing embodiments, determination of the presence of the flammable compound is based on a speed of sound measured with the airflow path in a non-active condition.

In any one or combination of the foregoing embodiments, an active flow condition is induced in response to a determination of the presence of the flammable compound.

In any one or combination of the foregoing embodiments, the speed of sound through air on the airflow path is measured with a sonic sensor comprising:

a housing including an active flow inlet in operative fluid communication with the airflow path, an active flow outlet in operative fluid communication with the airflow path, and a measured flow path within the housing between the active flow inlet and the active flow outlet, and

a first ultrasonic transceiver configured to generate a sonic signal;

a second ultrasonic transceiver receive a sonic signal, said first and second ultrasonic transceivers arranged to provide a sonic pathway through the measured flow path; and

a plurality of diffusion openings in the housing configured to provide operative molecular diffusion communication between outside of the housing and the sonic pathway.

A combination sensor for gas composition and gas flow is also disclosed. The sensor includes a housing including an active flow inlet, an active flow outlet, and a measured flow path within the housing between the active flow inlet and the active flow outlet. The sensor includes a first ultrasonic transceiver configured to generate a sonic signal, and a second ultrasonic transceiver configured to receive a sonic signal. The first and second ultrasonic transceivers are arranged to provide a sonic pathway through the measured flow path. The housing includes a plurality of diffusion openings configured to provide operative molecular diffusion communication between outside of the housing and the sonic pathway.

In any one or combination of the foregoing embodiments, the first ultrasonic transceiver and the second ultrasonic transceiver are each configured to both generate and receive a sonic signal.

In any one or combination of the foregoing embodiments, the diffusion openings include a diffusion medium that inhibits bulk gas flow through the diffusion openings.

In any one or combination of the foregoing embodiments, the flow medium includes a mesh, screen, or membrane.

In any one or combination of the foregoing embodiments, the housing and the ultrasonic transceivers are configured to provide a direct sonic pathway between the first and second ultrasonic transceivers.

In any one or combination of the foregoing embodiments, the housing and the ultrasonic transceivers are configured to provide an indirect sonic pathway between the first and second ultrasonic transceivers.

In any one or combination of the foregoing embodiments, the diffusion openings are disposed along a housing wall extending parallel to the ultrasonic pathway.

In any one or combination of the foregoing embodiments, the measured flow path extends in a non-parallel direction to a gas flow direction outside of the housing.

In any one or combination of the foregoing embodiments, the measured flow path extends in a direction perpendicular to the gas flow direction outside of the housing.

### BRIEF DESCRIPTION OF THE DRAWINGS

The following descriptions should not be considered limiting in any way. With reference to the accompanying drawings, like elements are numbered alike:

FIG. 1 is an illustration of a residential heating and cooling system;

FIG. 2 is a schematic depiction of an example embodiment of an ultrasonic sensor;

FIG. 3 is a schematic depiction of another example embodiment of an ultrasonic sensor;

FIG. 4 is a flow chart of an example embodiment of a logic routine for ascertaining flammable refrigerant leaks and airflow conditions; and

FIG. 5 describes an example embodiment of a logic routine invoked when electrical heater is demanded by the system for space heating in a system with flammable refrigerants.

### DETAILED DESCRIPTION

A detailed description of one or more embodiments of the disclosed apparatus and method are presented herein by way of exemplification and not limitation with reference to the Figures.

The above types of sensors have been used with varying degrees of success in the industrial or laboratory settings where they have been employed. However, many such sensors have limitations that can impact their effectiveness in demanding new and existing applications. For example, pellistor sensors are prone to false alarms due to cross-sensitivity. NDIR sensors can provide good selectivity, but are expensive for high volume applications. Electrochemical sensors rely on redox reactions involving tested gas components at electrodes separated by an electrolyte that produce or affect electrical current in a circuit connecting the electrodes. However, solid state electrochemical sensors can be prone to nuisance alarms due to poor selectivity. Additionally, solid state electrochemical sensors testing for combustible hydrocarbons may utilize solid electrolytes formed from ceramics such as perovskite, which can require high temperatures (typically in excess of 500° C.) that render them impractical for many applications that require long lifetime. Some electrochemical sensors that operate at lower temperatures (e.g., carbon monoxide sensors, hydrogen sulfide sensors) are incapable of electrochemically oxidizing relatively stable organic compounds that nevertheless be flammable or mildly flammable, such as some hydrofluoro carbon refrigerants (note, as used herein, the term “flammable” includes any flammable compound regardless of degree of flammability, including refrigerants rated as flammable and mildly flammable).

MOS sensors rely on interaction between gas test components such as hydrogen sulfide or hydrocarbons with adsorbed oxygen on the metal oxide semiconductor surface. In the absence of the gas test components, the metal oxide semiconductor adsorbs atmospheric oxygen at the surface, and this adsorbed oxygen captures free electrons from the metal oxide semiconductor material, resulting in a measurable level of base resistance of the semiconductor at a relatively high level. Upon exposure to reducing or combustible gas test components such as hydrocarbons or hydrofluorocarbons (HFCs), the gas test component interacts with the adsorbed oxygen, causing it to release free electrons back to the semiconductor material, resulting in a measurable decrease in resistance that can be correlated with a measured level of test gas component. Though MOS sensors are relatively inexpensive, their lifetime is typically far shorter than that of the HVAC equipment, rendering scheduled sensor replacement necessary, and cost of such service can often be unfavorable compared with other longer lifetime sensors with relatively higher cost.

In the HVAC/R industry, more environmentally friendly refrigerants are being developed and used to replace refrigerants with high global warming potentials (GWP) such as R134A and R410A. Many of the low GWP refrigerants are flammable (A3 refrigerants such as R290 i.e. propane) or mildly flammable (A2L refrigerants such as R32, R1234ze etc.). In refrigerant leak detection applications involving testing for compounds foreign to ambient air, false alarms can be a problem, potentially interrupting system operations. Various leak detection technologies have been proposed to address potential fire hazards from flammable refrigerants in interior building spaces; however, there continues to be a need to provide scalable cost-effective detection technologies capable of discerning refrigerant leaks from nuisance alarms.

In some residential HVAC equipment used in cold climates, electrical heaters can be included to provide heating in cold seasons. During operation, electrical heaters are exposed to air, which is the heat transfer fluid for direct electrical heating. Hot surfaces of such heaters can be a potential ignition source for mildly flammable or flammable refrigerants in case of refrigerant leaks. It has been determined that adequate airflows will not only dissipate refrigerants leaking from the system, but also greatly suppress ignition and subsequently fire hazards. Therefore, there is a need detect active airflow as a premise for energizing electrical heaters or any other potential ignition sources in a residential cooling and heating equipment using flammable refrigerants. Unfortunately, additional flow sensors will add extra complexity to the system design and integration of multiple components with both refrigerant leak detection and airflow sensors, as well as driving up cost. Embodiments of this disclosure can provide a significant technical benefit of combining both leak and airflow detection in a single sensor.

As mentioned above, the systems and methods described herein utilize an ultrasound-based sensor to detect both the presence of gas species and airflows based on the dependence of speed of sound or frequency of sound on gas compositions and airflow rates. In some embodiments, the gas in question can be room air being conditioned by an air conditioner or heat pump, and the additional gas species being tested for can be refrigerant from a refrigerant leak.

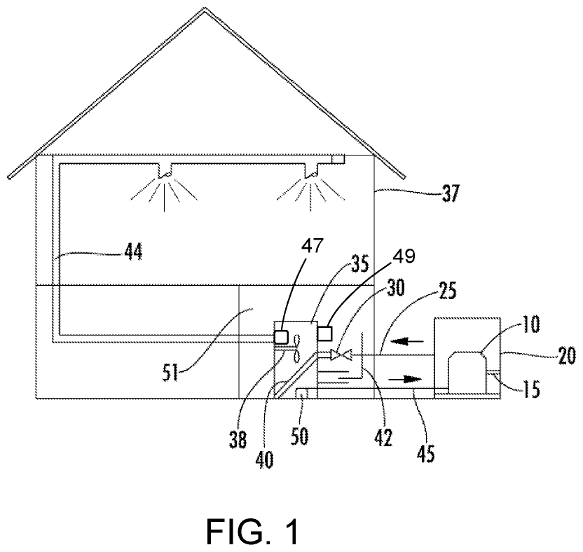

An example embodiment of a heat transfer system with integrated sensors for monitoring for accidentally leaked heat transfer fluid is shown in FIG. 1. As shown in FIG. 1, a heat transfer system includes a compressor 10 which pressurizes the refrigerant or heat transfer fluid in its gaseous state, which both heats the fluid and provides pressure to circulate it throughout the system. The hot pressurized gaseous heat transfer fluid exiting from the compressor 10 flows through conduit 15 to outdoor heat exchanger 20, which in air conditioning mode functions as a heat exchanger to transfer heat from the heat transfer fluid to the surrounding environment, resulting in condensation of the hot gaseous heat transfer fluid to a pressurized moderate temperature liquid. In air conditioning mode, the liquid heat transfer fluid exiting from the outdoor heat exchanger 20 flows through conduit 25 to expansion valve 30, where the pressure is reduced. The reduced pressure liquid heat transfer fluid exiting the expansion valve 30 flows to a fan coil unit 35 inside the building 37, which includes fan 38 and indoor heat exchanger 40, which in air conditioning mode functions as a heat exchanger to absorb heat from or reject heat to the surrounding environment and boil the heat transfer fluid. In air conditioning mode, refrigerant in the indoor heat exchanger 40 absorbs heat from a conditioned airflow path that includes a return air conduit 42 that returns air from the conditioned air space inside the building 37 and a supply air conduit 44 that supplies conditioned air to the conditioned air space inside the building 37. Gaseous heat transfer fluid exiting the indoor heat exchanger 40 flows through conduit 45 to the compressor 10, thus completing the heat transfer fluid loop. The heat transfer system can transfer heat between the environment surrounding to the indoor heat exchanger 40 and the environment surrounding the outdoor heat exchanger 20, as described above for air conditioning mode. In heat pump mode, the indoor heat exchanger serves as a condenser and the outdoor heat exchanger serves as an evaporator, and fluid flows are redirected to provide expansion and compression at appropriate stages of the vapor compression refrigerant flow loop. Also, a heater (e.g., an electric heater) 47 provides auxiliary or supplemental heating for heat pump operations at low outside temperatures when heat demand cannot be satisfied exclusively by heat transferred from the outside. The thermodynamic properties of the heat transfer fluid allow it to reach a high enough temperature when compressed so that it is greater than the environment surrounding the condensing heat exchanger, allowing heat to be transferred to the surrounding environment. The thermodynamic properties of the heat transfer fluid should also have a boiling point at its post-expansion pressure that allows the environment surrounding the heat rejection heat exchanger to provide heat at a temperature to vaporize the liquid heat transfer fluid.

As further shown in FIG. 1, the heat transfer system further includes sensor pack 50, which can be placed in the indoor section of the system to detect refrigerant leaks that can potential pose risks to the building and occupants. The multifunctional sensor with auxiliary sensing elements besides the primary leak detection sensor is place in the unit along the airflow path to allow for monitoring the gas phase composition changes and active airflows. As mentioned above an ultrasonic sensor in the sensor pack 50 can be operated to detect a presence of a flammable gas in air along the unit's airflow path and also to detect airflows. The sensor, and other equipment such as valves, motors, other sensors (e.g., temperature, humidity), system operator input, and the like can be connected with wired connections (not shown) or wirelessly to a controller such as microprocessor 49.

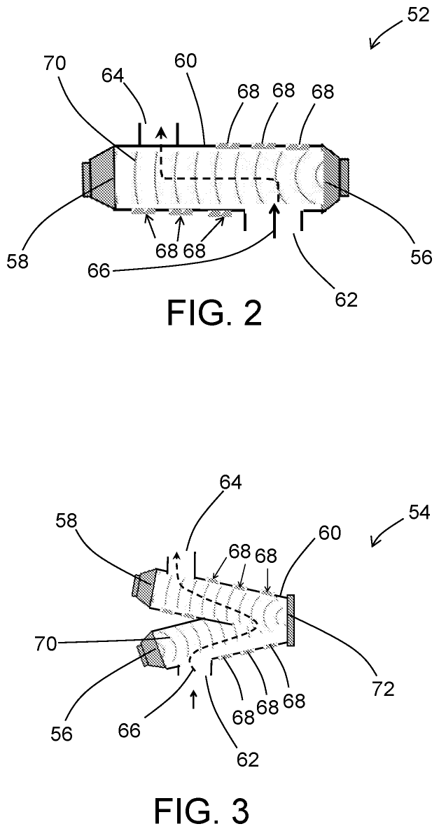

Example embodiments of sonic sensors 52 and 54 are shown in FIGS. 2 and 3. With reference to FIGS. 2 and 3, the sonic sensor 52/54 includes an ultrasonic transceiver 56 and an ultrasonic transceiver 58 disposed in a housing conduit 60. The housing 60 includes an active flow inlet 62 and an active flow outlet 64, through which air is transported along a flow path 66 (i.e., a measured flow path) during active airflow. The active flow inlet 62, the active flow outlet 64, and the conduit 60 can be configured and positioned in a conduit (e.g., that contains an airflow path configured for active airflow). Active airflow can be characterized as directional bulk airflow involving mass transport of air. The body of the conduit 60 can optionally include ports 68, with filters that allow for air to diffuse into the path of sound propagation for detecting of refrigerant when the fan is not activated. In some embodiments, the active flow inlet and outlet 62/64 and the housing 60 can be positioned and configured to provide the flow path 66 with a direction that is not parallel with the direction of active airflow outside of the sensor. In some embodiments, such as shown in the flow path 66 can be perpendicular to the direction of active airflow outside of the sensor, such as shown for sensor 52 in FIG. 2. The ports 68 act as diffusion openings that allow for molecular diffusion therethrough, and can take on a variety of configurations. It is noted that although the active flow inlet and outlet 62/64 can also allow molecular diffusion therethrough in addition to allowing active flow therethrough, the diffusion openings are distinct from the active flow inlet and outlet 62/64. In some embodiments, the ports 68 can include a diffusion medium such as a mesh, screen, or membrane. In some embodiments, such as the embodiments of FIGS. 2 and 3, the ports 68 can be congregated together in a discrete segment of the housing 60 in which a diffusion medium is disposed. In other embodiments, small openings can be dispersed across larger portions of the housing 60 or even across the entire housing, e.g., a perforated conduit 60. The conduit 60 can be designed to guide airflows in the direction of an outside airflow (e.g., HVAC forced return air) to enhance the detectability of active airflow. Therefore, in some embodiments the multifunctional sensor can be aligned with direction of air stream in the equipment. The additional ports 68 can ensure adequate response time even if refrigerant leaking the system doesn't enter the sensor conduit from the open ports 62 and 64.

In some embodiments, the ultrasonic transceivers 56/58 can each emit and receive a sonic signal, allowing for sonic signals to be sent in opposite directions along a sonic pathway 70 (i.e., flight path), although mono-directional sonic signals can also be used, in which case the ultrasonic transceivers can 56/58 can each be configured to handle only one of the sending/receiving duties. In some embodiments such as shown in FIGS. 2 and 3, the sonic pathway 70 of sound between the ultrasonic transceivers 56 and 58 can follow the same path as the flow path as the flow path 66. In some embodiments, the sonic pathway 70 can be direct as shown in FIG. 2, or it can be indirect as shown in FIG. 3. The sensor 54 shown in FIG. 3 includes a sonic reflector 72 that redirects the sound waves along the sonic pathway between the ultrasonic transceivers 56 and 58. The sonic reflector can be made from any smooth material such as glass, metal, or plastic.

In operation, an ultrasonic transceiver 56 or 58 can emit a sonic signal as a short burst or containing a time value encoded in the signal, which is received by the other ultrasonic transceiver and a time of flight between transceivers recorded by microprocessor 49 (FIG. 1). As mentioned above, a second sonic signal can be sent in the opposite direction and the time of flight recorded. As mentioned above, the sonic sensor 52/54 can detect the change in gas compositions such as the presence of a flammable compound (e.g., a refrigerant with a class 2, 2L, or 3 flammability rating according to ASHRA 34-2016. In some embodiments, the presence of a gas composition different from ambient air is a function of the times for ultrasound to propagate in a bi-directional fashion. Specifically, the gas composition changes can be determined by measuring sonic signal times of flight or ultrasound frequency in two directions, upstream and downstream in some cases, according the equation (1):

$$f ( c ) = \frac{T 1 + T 2}{T 1 \times T 2}$$

where c is a gas concentration, T1 is a sonic time of flight in a first direction, and T2 is a sonic time of flight in a second direction.

In some embodiments, a flow rate or condition can be determined by by measuring sonic signal times of flight in two directions according the equation (2):

$$f ( v ) = \frac{T 1 + T 2}{T 1 \times T 2} - {[ \frac{T 1 + T 2}{T 1 \times T 2} ]}_{baseline}$$

where v is a flow rate or condition, T1 is a sonic time of flight in a first direction, and T2 is a sonic time of flight in a second direction. In some embodiments, sonic measurements can be used to determine a gas flow rate. A measured speed of sound through the gas can be calculated based on elapsed time for the signal, and compared to stored data such as a look-up table based for example on test data calibrated according to equation (2). In some embodiments, an actual flow rate is not needed, but only confirmation that a certain flow condition has been achieved, e.g., that active flow has begun in response to activation of a fan or blower, and the f(v) value is compared to a threshold value indicative of the flow condition (active flow vs. not active flow) instead of being recorded as a measured flow rate. In some embodiments, a flow condition characterized as non-active can include a stagnant, still, or standing body of air, i.e., air with no appreciable flow rate.

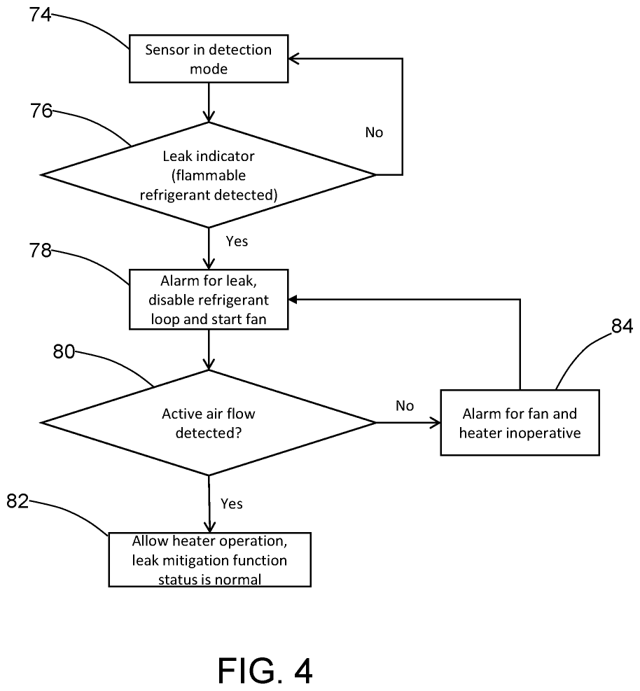

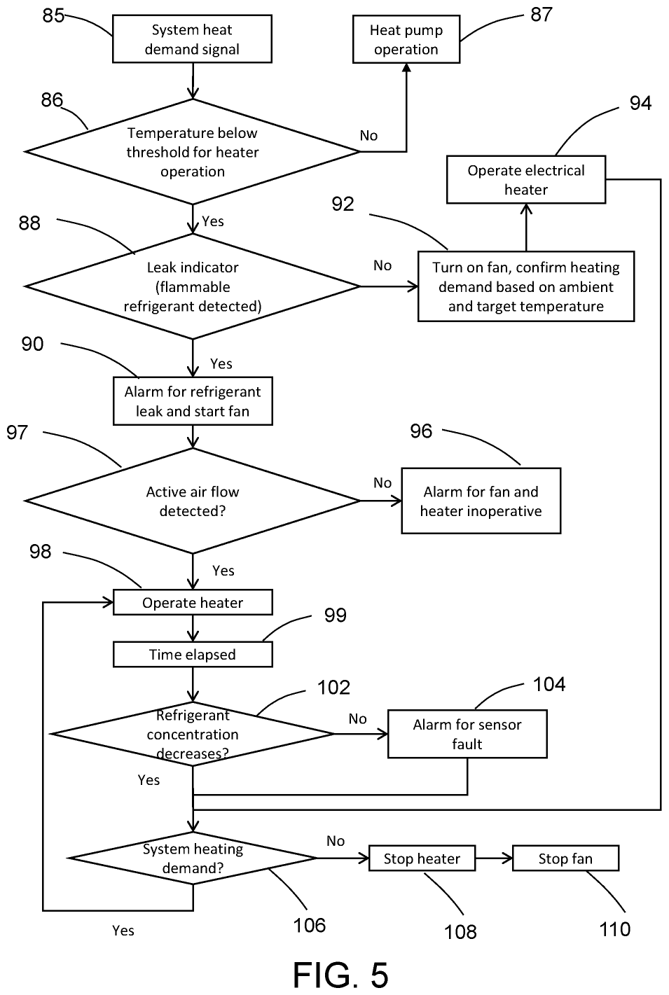

Protocols for operating a sonic sensing device or system to detect gas contaminants such as flammable refrigerant leaks and to characterize a flow condition gas leaks in FIGS. 4 and 5. The embodiments of FIGS. 4-5 show logic that can be used in an HVAC system such as the system of FIG. 1. With reference first to FIG. 4, the operation begins with a sonic sensor (e.g., sensor 52/54 of FIGS. 2-3) in detection mode at block 74. In detection mode, the sensor can send periodic sonic pulses along the sonic pathway 70 and during operating conditions when active flow is not present (i.e., the fan 38 is off). The measured times of flight or frequency for these sonic pulses can be compared to stored data such as a look-up table based for example on test data calibrated according to equation (1) at decision block 76. In the event that f(c) does not exceed a threshold value, a determination is made that no refrigerant leak is indicated and the operation returns to detection mode at block 74. In the event that f(c) exceeds the threshold value, a determination is made that a refrigerant leak is indicated and the operation proceeds to block 78, where a system alarm is made for a detected leak, operation of the refrigerant loop is disabled if the system was operational when leak is confirmed, and mitigation procedures are begun by turning on the fan 38. After turning on the fan, a confirmation active airflow can be made by sending sonic pulses along the sonic pathway 70, and comparing measured times of flight or frequency for these sonic pulses to stored data such as a look-up table based for example on test data calibrated according to equation (2) at decision block 80. In the event that f(v) exceeds a threshold value, a determination is made that active flow is detected, and the operation proceeds to block 82 where heater operation is allowable so that system control can turn on the heater 47 in response to a system heat demand signal (with heat pump operation disabled in response to the leak). In the event that f(v) does not exceed the threshold value, a determination is made that active flow is not detected, and the operation proceeds to block 84 where an alarm is made for a fan and heater inoperative condition, and then to block 78 where activation of the fan 38 can be re-tried.

Another example embodiment of logic for an operating protocol in response to a heat demand signal from system control (e.g., in response to a comparison of temperature in a conditioned space versus an operator-entered temperature setting) is shown in FIG. 5. As shown in FIG. 5, a system heat demand signal is received/generated at block 85. At this point, the fan 38 should be in an off condition based on a prior system condition in which a heat demand signal was not present. From block 85, the operation proceeds to decision block 86, where exterior temperature is compared to a predetermined value to determine whether activation of the heater 47 is required. If temperature is not above the predetermined value, the operation proceeds to block 87 where heating is provided by normal heat pump operation. If the exterior temperature is below the predetermined value, then the operation proceeds to block 88 where a determination is made of whether the presence of flammable refrigerant exceeds a pre-determined value. At block 88, the sensor 52/54 sends sonic pulses along the sonic pathway 70, and the measured times of flight for these sonic pulses are compared to stored data such as a look-up table based for example on test data calibrated according to equation (1). In the event that f(c) exceeds the threshold value, a determination is made that a refrigerant leak is indicated and the operation proceeds to block 90, where a system alarm is made for a detected leak, operation of the refrigerant loop is disabled, and mitigation procedures are begun by turning on the fan 38. In the event that f(c) does not exceed a threshold value at decision block 88, a determination is made that no refrigerant leak is indicated. In some embodiments, with no refrigerant leak having been detected, a fan can be turned first before the heater is activated for space heating as shown in block 92. In case of a refrigerant leak detected by the sensor in block 88, the fan will be turned on first, and the operation proceeds to block 97 where the sensor 52/54 sends sonic pulses along the sonic pathway 70, and the measured times of flight for these sonic pulses are compared to stored data such as a look-up table based for example on test data calibrated according to equation (2). Upon airflow confirmation and pre-set time delay to dissipate residual refrigerant in the system, the electrical heater can be turned on as indicated in block 98, and the operation proceeds to elapsed time block 99. The time delay at block 9 can range from 30 seconds to 5 mins, depending on factors such as the amount of refrigerant anticipated to leak from the system and considering worst case scenarios. Under the circumstance of a detected refrigerant leak, further diagnostics can be performed while space heating is activated. As shown in blocks 99 and 102, the refrigerant leak sensor can continually or repeatedly track the refrigerant concentration to determine if the flammable mass has been dissipated by circulated air as expected. If refrigerant doesn't dissipate as expected, a sensor fault can be determined and alarmed at block 104 on the premise that active airflow is available. When refrigerant dissipation occurs as designed, the demand for heating can be assessed in block 106, and if space heating is needed, the logic returns to block 98 for operation of the heater. Otherwise, the electrical heater is turned off first at block 108 before the fan is turned off at block 110.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. (canceled)

2. An air conditioning or heat pump system, comprising
an airflow path in operative fluid communication with a conditioned space;
a first heat exchanger comprising a first side in operative fluid communication with the conditioned airflow path, and a second side in operative thermal communication with the first side and in operative fluid communication with a refrigerant that comprises a flammable compound;
an enclosed refrigerant flow path comprising the refrigerant and connecting the second side of the first heat exchanger with a second heat exchanger in thermal communication with an external heat source or heat sink;
an ultrasonic sensor in operative fluid communication with the airflow path, configured to measure a speed of sound through air on the airflow path;
a microprocessor configured to characterize a flow condition of the airflow as active or non-active by a measured speed or frequency of sound through air on the airflow path, and further configured to determine a presence of the flammable compound by a measured speed or frequency of sound through air on the airflow path.

3. The system of claim 2, wherein the refrigerant has a class 2 or class 2L or class 3 flammability rating according to ASHRAE 34-2016.

4. The system of claim 2, wherein the airflow path includes a fan configured to induce the active flow condition and the fan is activated in response to the determination of a presence of a flammable compound.

5. (canceled)

6. The system of claim 2, wherein the determination of the flow condition, the presence of the flammable compound or both is based on transit times of a bi-directional sonic signal across a fixed distance through air on the airflow path.

7. (canceled)

8. The system of claim 2, wherein the airflow path includes a heater, and wherein activation of the heater requires determination of an active flow condition on the airflow path.

9. A system according to claim 8, wherein the heater is configured to be activated in response to a system heat demand signal in a condition of heat pump shut-down initiated by a determination of the presence of the flammable compound.

10. The system of claim 2, wherein determination of the presence of the flammable compound is based on a speed of sound measured with the airflow path in a non-active flow condition and an active flow condition is induced in response to a determination of the presence of the flammable compound.

11. (canceled)

12. The system of claim 2, wherein speed of sound through air on the airflow path is measured with a sonic sensor comprising:
a housing including an active flow inlet in operative fluid communication with the airflow path, an active flow outlet in operative fluid communication with the airflow path, and a measured flow path within the housing between the active flow inlet and the active flow outlet, and
a first ultrasonic transceiver configured to generate a sonic signal;
a second ultrasonic transceiver receive a sonic signal, said first and second ultrasonic transceivers arranged to provide a sonic pathway through the measured flow path; and
a plurality of diffusion openings in the housing configured to provide operative molecular diffusion communication between outside of the housing and the sonic pathway.

13. A combination sensor for gas composition and gas flow, comprising
a housing including an active flow inlet, an active flow outlet, and a measured flow path within the housing between the active flow inlet and the active flow outlet;
a first ultrasonic transceiver configured to generate a sonic signal;
a second ultrasonic transceiver configured to receive a sonic signal, said first and second ultrasonic transceivers arranged to provide a sonic pathway through the measured flow path; and
a plurality of diffusion openings in the housing configured to provide operative molecular diffusion communication between outside of the housing and the sonic pathway.

14. (canceled)

15. The sensor of claim 13, wherein the diffusion openings include a diffusion medium that inhibits bulk gas flow through the diffusion openings.

16. The sensor of claim 15, wherein the flow medium includes a mesh, screen, or membrane.

17. The sensor of claim 13, wherein the housing and the ultrasonic transceivers are configured to provide a direct sonic pathway between the first and second ultrasonic transceivers.

18. The sensor of claim 13, wherein the housing and the ultrasonic transceivers are configured to provide an indirect sonic pathway between the first and second ultrasonic transceivers.

19. The sensor of claim 13, wherein the diffusion openings are disposed along a housing wall extending parallel to the ultrasonic pathway.

20. The sensor of claim 13, wherein the measured flow path extends in a non-parallel direction to a gas flow direction outside of the housing.

21. (canceled)

22. A method of monitoring airflow along an airflow path, comprising:
measuring a speed or frequency of sound through air on the airflow path;
determining a flow condition of the airflow as active or non-active, based on a measured speed or frequency of sound through air on the airflow path; and
determining a presence of a flammable compound, based on a measured speed or frequency of sound through air on the airflow path.

23. The method of claim 22, wherein the airflow path includes a fan configured to induce the active flow condition and the fan is activated in response to the determination of a presence of a flammable compound.

24. The method claim 22, wherein the determination of the flow condition and the presence of the flammable compound is based on transit times of a bi-directional sonic signal across a fixed distance through air on the airflow path.

25. The method claim 22, wherein the airflow path includes a heater, and wherein activation of the heater requires determination of an active flow condition on the airflow path.

26. The method claim 22, wherein determination of the presence of the flammable compound is based on a speed of sound measured with the airflow path in a non-active flow condition and further wherein an active flow condition is induced in response to a determination of the presence of the flammable compound.
